(19) United States
(12) Patent Application Publication
(10) Pub. No.: US 2003/0051764 A1
(43) Pub. Date: Mar. 20, 2003

(54) Air handling system ductwork component and method of manufacture

(76) Inventor: Jon W. Jungers, Zimmerman, MN (US)

Correspondence Address: Timothy A. Czaja, Dicke, Billig & Czaja, P.A., 701 Building, Suite 1250, 701 Fourth Avenue South, Minneapolis, MN, 55415, US

(21) Appl. No.: 10/252,032

(22) Filed: Sep. 19, 2002

Related U.S. Application Data
(60) Provisional application No. 60/324,160, filed on Sep. 20, 2001.

(51) Int. Cl. F16L 9/14

(52) U.S. Cl. 138/149; 138/141

(57) ABSTRACT

An air handling system ductwork component comprising a tubular, foam interior layer integrally formed with a thin, non-metal outer layer. The combination interior and outer layers are characterized as providing requisite strength for use of the ductwork component within an air handling system without inclusion of a metal-based layer. In one preferred embodiment, the interior layer is a closed cell foam, and the outer layer is plastic, with the ductwork component being formed as part of a rotational molding process. The ductwork component can assume a wide variety of forms, such as a duct, pipe, elbow, boot, tee, plenum, reducer, register, wall stack, take-off, etc.

### CROSS-REFERENCE TO RELATED APPLICATION

This application claims priority to provisional patent application Serial No. 60/324,160 filed on Sep. 20, 2001, the teachings of which are incorporated herein by reference.

### BACKGROUND OF THE INVENTION

The present invention relates to ductwork components for air handling systems such as residential, commercial, or industrial heating, ventilating, and air conditioning (HVAC) systems. More particularly, it relates to an integrally formed, foam-based air handling system ductwork component(s) exhibiting superior handling and performance properties.

Residential, commercial, and industrial air handling systems include various ductwork components used to direct heated, cooled, and/or filtered air from a source to one or more rooms. More particularly, the air handling system can include a heating system (e.g., furnace, heat pump, electrical heat, etc.), cooling system (e.g., air conditioner), and/or a filtering system. Regardless of the manner in which air is treated, ductwork components direct the treated air (typically via fan(s) or blower(s)) to the room(s) of interest. The ductwork components can include one or more of a plenum (e.g., hot air plenum, cold air straight plenum, cold air plenum with furnace take-off), hot air take-offs, ducts, pipes (e.g., straight or bent), boots, wall stacks, registers (e.g., wall or floor registers), tees, reducers, etc. (hereinafter referred to as “ductwork components”). These ductwork components are traditionally formed of metal; more particular, galvanized stainless steel or sheet metal. While well accepted, stainless steel or sheet metal ductwork components are characterized by a number of potential drawbacks.

For example, metal ductwork components are not energy efficient. Heat transfer across a thickness of the component readily occurs, especially during periods of inactivity. Similarly, difficulties are often encountered when joining two separate ductwork components (e.g. a duct to a plenum; a register to a boot; etc.) due to variation in size. Along these same lines, it is virtually impossible to achieve an airtight seal between two joined ductwork components; instead, an additional sealing material (e.g. duct tape) must be employed to ensure an airtight junction. Due to the extra time required to apply this auxiliary sealant, installers operating under tight deadlines may be forced to forego their use. This failure, in turn, may lead to the introduction of unwanted molds, dust, and bacteria into the air handling system ductwork. Further, the sharp corners associated with many metal ductwork components are dangerous and may cause injuries during installation. Also, though galvanized stainless steel is quite robust, deterioration or rupturing will inevitably occur over time due in large part to corrosion.

Efforts have been made to address at least one of the above-identified concerns. Namely, a separate layer of insulation is often wrapped around pipe ductwork components to minimize undesirable heat transfer. The separately formed insulation layer(s) is expensive and entails handling difficulties and additional installation time. Alternatively, U.S. Pat. No. 3,352,326 to Gustafson describes a prefabricated duct for an air conditioning system consisting of inner and outer metal tubes maintaining an intermediate fiberglass insulation material. Unfortunately, the prefabricated ducts are not adapted to retrofit existing systems. Similarly, ductboard is available that incorporates an intermediate insulation layer as described, for example, in U.S. Pat. No. 5,918,644. Regardless of exact construction, ductboard is provided in a sheet or blank form, and then bent to form a duct. As such, ductboard has minimal structural strength and is limited to above ground, separately reinforced air duct applications. A further drawback common to each of the above described ductwork insulation techniques is that they are limited to only pipe and duct components. Likely due to the greatly increased costs associated with these techniques, no efforts have been made to provide other ductwork components (e.g., plenums, boots, etc.) with an insulation layer.

Substantial efforts have been expended into improving the design and performance of the “major” air handling system components such as furnaces and air conditioners. However, the ductwork components are essentially unchanged, relying solely upon traditional metal fabrication. Any improvements to this metal design could revolutionize the residential, commercial, and industrial air handling system industry. Unfortunately, previous efforts have not produced commercially viable results. Therefore, a need exists for air handling system ductwork components that are integrally formed to include a layer of insulation and that can be produced on a cost effective basis.

### SUMMARY OF THE INVENTION

One aspect of the present invention relates to a ductwork component for an air handling system comprising a tubular, foam interior layer integrally formed with a thin, non-metal outer layer. The combination interior and outer layers are characterized as providing requisite strength for use of the component within an air handling system without inclusion of a metal-based layer. In one preferred embodiment, the interior layer is a closed cell foam and the outer layer is plastic. Regardless, the ductwork component can assume a wide variety of forms, such as a duct, pipe, elbow, boot, tee, register, wall stack, take-off, plenum, etc.

Another aspect of the present invention relates to a method of manufacturing a ductwork component for an air handling system. The method includes providing a foam-related material and a plastic material. The foam-related material is molded with the plastic material to form the ductwork component comprising a tubular interior foam layer and an outer plastic layer. In this regard, the molding results in the ductwork component being adapted for use in an air handling system and having requisite strength without requiring an additional metal layer. In one preferred embodiment, a rotational molding operation is used to form the ductwork component.

Another aspect of the present invention relates to a method of replacing an existing metal ductwork component of an air handling system. The method includes providing a molded, foam-based ductwork component sized and shaped to replicate a size and shape of the metal ductwork component. The metal ductwork component is removed from the air handling system. Finally, the foam-based ductwork component is mounted within the air handling system so as to replace the metal ductwork component. In this regard, the foam-based ductwork component is sufficiently rigid to maintain its position within the air handling system independent of a separate metal layer or support.

Yet another aspect of the present invention relates to ductwork for an air handling system comprising a plenum, at least one duct, and at least one register. In this regard, at least one of the plenum, duct, and register consist of a tubular, foam interior layer integrally formed with a thin, non-metal outer layer. The combination interior and outer layers are characterized as providing requisite strength for use of the component within the air handling system without inclusion of a metal-based layer.

### BRIEF DESCRIPTION OF THE DRAWINGS

FIG. 1 is an exploded view of an HVAC air handling system including components in accordance with the present invention;

FIG. 2A is an enlarged, transverse, cross-sectional view of a portion of a duct of FIG. 1;

FIG. 2B is an enlarged, transverse, cross-sectional view of a portion of an alternative embodiment duct in accordance with the present invention;

FIG. 2C is a longitudinal, cross-sectional view of a duct of FIG. 1;

FIGS. 3A-3C are perspective views of plenum ductwork components in accordance with the present invention;

FIGS. 4A and 4B are perspective views of pipe ductwork components in accordance with the present invention;

FIGS. 5A and 5B are perspective views of take-off ductwork components in accordance with the present invention;

FIGS. 6A-6D are perspective views of boot ductwork components in accordance with the present invention; and

FIG. 7 is a perspective view of a wall stack ductwork component in accordance with the present invention.

### DETAILED DESCRIPTION OF THE PREFERRED EMBODIMENTS

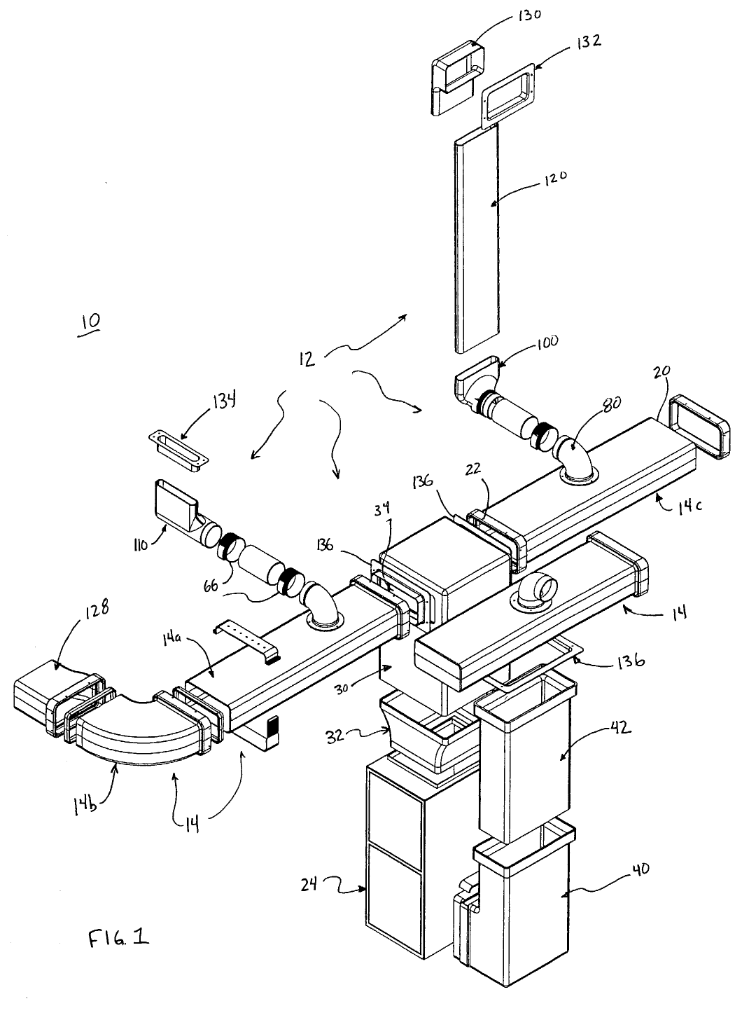

An air handling system 10 incorporating ductwork components (referenced generally at 12) in accordance with the present invention is shown in FIG. 1. In this regard, the air handling system 10 of FIG. 1 reflects but one of a multitude of possible configurations with which the present invention is useful. That is to say, air handling systems, such as the system 10 of FIG. 1, are designed to satisfy the needs of the particular residential, commercial, or industrial installation. Thus, depending upon the particular installation requirements, additional ones of the ductwork components 12 shown in FIG. 1 may be included and/or others of the ductwork components 12 eliminated. However, at least one of the ductwork components 12, preferably all of the ductwork components 12, of the particular system installation is an integrally formed, foam-based body that provides requisite structural strength and airflow handling capabilities without the requirement of a separate metal layer. The component(s) 12 in accordance with the present invention is a greatly enhanced substitute for the traditional, galvanized stainless steel or sheet metal ductwork component design that inherently requires a separately wrapped insulation material to limit heat transfer losses.

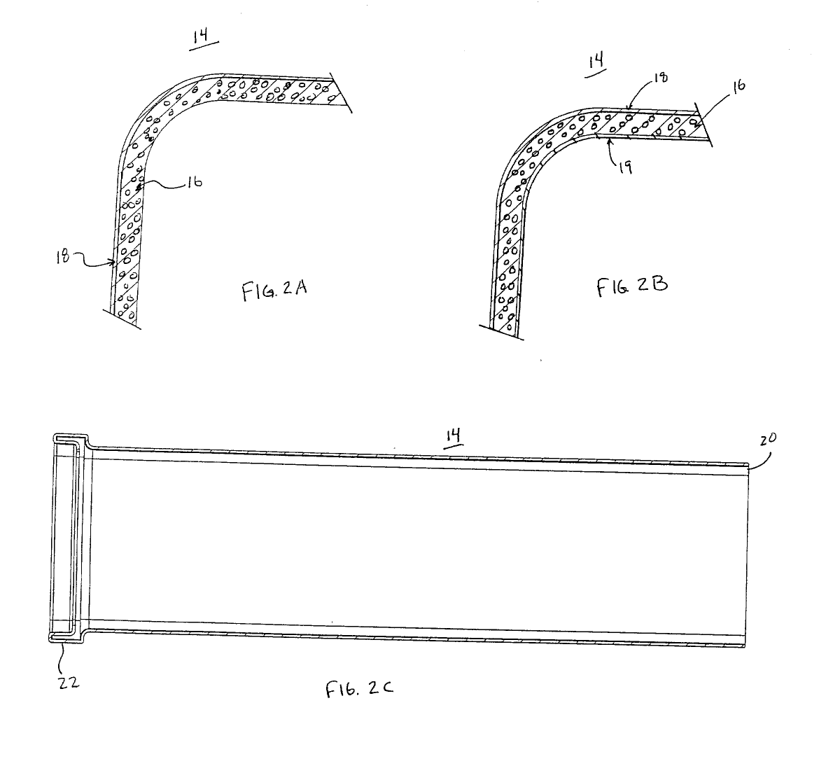

With the above in mind, an exemplary component 12 in accordance with the present invention is an air duct 14 (referenced generally in FIG. 1). In terms of overall size and shape, the duct 14 replicates ducts commonly employed in residential, commercial, or industrial air handling system applications, and thus can be straight (e.g., the duct 14a in FIG. 1) or curved (e.g., the duct 14b in FIG. 1). One example of the duct 14 is shown in greater detail by the cross-sectional view of FIG. 2A and includes an interior layer 16 and an outer layer 18. In general terms, the interior layer 16 is a molded foam, whereas the outer layer 18 is plastic. With this construction, the interior and outer layer 16, 18 are bonded to one another, with the interior, foam layer 16 providing sufficient rigidity to fully support the duct 14 within the air handling system 10.

As used throughout this specification, a “foam” or “foam material” is a lightweight cellular material resulting from the introduction of gas bubbles into a reacting polymer. With this definition in mind, the interior foam layer 16 is preferably a molded, hardened or rigid foam having a relatively high density, such as that normally associated with molded polyethylene foam as described below. These preferred foam characteristics render the interior foam layer 16 to have a high compression modulus or support factor sufficient for the duct 14 (or other ductwork component as described below) to rigidly maintain its shape over long periods of time (at least ten years) when subjected to forces normally encountered in a residential, commercial, or industrial air handling system ductwork application (e.g., the duct 14 may be buried under ground, hung from a ceiling, etc.).

In light of the above-described characteristics associated with the foam interior layer 16 (e.g., molded, rigid foam), the outer layer 18 primarily serves as protective coating or skin that maintains an integrity of the duct's 14 exterior during handling and installation. In particular, the foam interior layer 16 can be somewhat friable; the outer layer 18 limits possible crumbling or flaking of the foam interior layer 16 in the event the duct 14 accidentally contacts another hard object. Further, as described below, the outer layer 18 provides a smooth, aesthetically pleasing exterior surface for the duct 14 and/or desired color. However, the outer layer 18 need not overtly support a structural rigidity of the inner foam layer 16, and thus' is a preferably thin, hardened plastic such as polyethylene. In particular, the outer layer 18 preferably has a thickness of less than 0.25 inch (6.35 mm), more preferably less than 0.125 inch (3.175 mm), most preferably less than 0.0625 inch (1.587 mm). Further, although the interior layer 16 and the outer layer 18 are depicted in FIG. 2A as being defined by a clear demarcation line, depending upon the particular manufacturing technique (e.g., rotational molding), a gradual transition from the foam interior layer 16 to the outer layer 18 can occur with the present invention. Regardless, the outer layer 18 does not include a metal, and is more dense and tougher than the foam interior layer 16.

In one preferred embodiment, the duct 14 is formed by a rotational molding (or roto-molding) technique. In general terms, rotational molding is a process in which parts are formed with heat and rotation. A mold that has been tooled to a desired shape (e.g., a duct) is placed in a rotational molding machine that provides loading, heating, and cooling areas. A pre-measured plastic resin is loaded into the mold in the machine loading area. Subsequently, the mold and resin are subjected to a source of heat to melt the plastic resin under controlled conditions. In particular, the mold is rotated bi-axially (vertically and horizontally) such that the melting resin sticks to the hot mold and evenly coats every surface thereof. The mold continues to rotate during a cooling cycle so that the resulting part retains an even wall thickness. Rotational molding has conventionally been employed to produce various plastic-only parts such as furniture and toys. With the present invention, however, it has surprisingly been found that an acceptable combination foam interior layer and plastic outer layer ductwork component can be provided via rotational molding.

In one preferred embodiment, the material used to rotational mold the duct 14 includes a plastic resin and a foaming agent. The selected plastic resin and foaming agent constituents are selected to generate the interior layer 16 as a rigid, closed cell foam and the outer layer 18 as a relatively thin, encapsulating plastic skin. In this regard, the preferred plastic resin is polyethylene, more preferably linear low-density polyethylene (LLDPE). Alternatively, other polyethylene formulations, such as high-density polyethylene (HDPE), low-density polyethylene (LDPE), etc., are acceptable. Even further, other plastic resins, such as other polyolefins, ethylene-vinyl acetate, polyvinyl chloride, polyester, nylon, polycarbonate, polyurethane, etc., can be employed. In one preferred embodiment, the plastic resin is LLDPE-based, available under the trade designation “LL8460” from ExxonMobile of Toronto, Ontario, Canada. Alternative plastic resin compounds are available, for example, from A. Schulman of Akron, Ohio, under the trade designation “LBAXL0360”.

The selected foaming agent in combination with the selected plastic resin generates the foam interior layer 16 during rotational molding. With this in mind, one preferred foaming agent is available under the trade name “Celogen” from UniRoyal Chemical Company, of Hartford, Conn., as an activated azodicarbonamide. When heated during the molding process, the foaming agent generates a gas that is trapped inside the molten plastic and causes it to foam. The material then has porous walls that are stiffer but lighter in weight than a solid wall of the same strength.

In a preferred embodiment, the molding compound consists of a ratio of plastic resin and foaming agent as approximately 2:3 (i.e., 40% plastic resin and 60% foaming agent). This one preferred ratio has surprisingly been found to result in a molded, highly rigid yet lightweight foam interior layer in combination with a hardened, smooth, aesthetically pleasing outer layer or skin. In this regard, the foaming agent is preferably added shortly after the heating/rotation cycling has begun. With this one preferred technique, the plastic resin melts and forms the thin outer layer 18, with the subsequently added foaming agent causing foaming to occur, with this foamed layer/material being integrally formed or bonded to the outer skin layer. Alternatively, a dry blend of the plastic resin and foaming agent can be combined and placed into the mold prior to heating/rotation, resulting in an integral skin foam. Even further, assembly techniques other than rotational molding can be employed, such as laminating the outer layer 18 to a preformed foam interior layer 16, injection molding the layers 16, 18, etc.

By preferably forming the interior layer 16 as a closed cell foam, a consistent interior surface is provided for directing airflow. That is to say, the interior layer 16 can be “exposed” to airflow (i.e., define the interior surface of the duct) without concern for airborne particles intimately interacting with individual cells of the foam interior layer 16 and/or air “leaking” through the foam interior layer 16. This is in direct contrast to previous rotational molded parts in unrelated fields that sandwich an insulative material between inner and outer plastic layers. However, in an alternative embodiment, the duct 14 further includes a molded inner layer 19, that in combination with the outer layer 18, encapsulates the foam interior layer 16 as shown in FIG. 2B. With this alternative approach, the interior foam layer 16 can assume other forms, such as an open cell foam.

Formulation of the molding compound can further include other additives that enhance certain characteristics of the resulting ductwork component. For example, the plastic and foaming agent components are preferably selected to provide the foam interior layer 16 with an elevated R value for enhanced insulative effects and thus be highly useful for extreme temperature applications (e.g., attic or crawl space). For example, in one preferred embodiment, the duct 14 can have an R value of eighteen or greater. Conversely, for air handling applications where an elevated R value is not a critical factor, the selected materials and/or resulting wall thickness can result in a lower R value. Additionally, a flame retardant additive can be employed.

Also, a desired colorant or pigment additive can be used to produce a desired exterior color for the duct 14. Any heat stable and unreactive colorants known and available for use with the selected plastic resin (and foaming agent with the preferred rotational molding technique) can be employed. Illustrative examples of useful colorants include carbon black, quinaeridone red, anthraquinone, and perinone dyes to name but a few. The resulting ductwork component (such as the duct 14) can thus be virtually any color, such as black, red, yellow, brown, etc. Other optional additives include fillers, tackifying agents, dispersing agents, UV stabilizers, and/or antioxidants.

Returning to FIG. 1, the molded duct 14 preferably defines a male end 20 and a female end 22. The female end 22 is an outwardly extending flange sized to directly receive a male end of a separate ductwork component as described in greater detail below. Further, the male end 20 and the female end 22 are precisely formed to provide an airtight seal when a separate ductwork component is mounted thereto. As best shown in FIG. 2C, the female end 22 defines an inner cross-sectional area greater than an inner cross-sectional area of the male end 20. More particularly, the inner dimensions of the female end 22 correspond with the outer dimensions of the male end 20. This represents a distinct advancement over current sheet metal ductwork components that require separate coupler components to assemble two ductwork pieces, along with a sealant to achieve an airtight seal. In this regard, the preferred rotational molding technique defines a smooth transition to the flanged female end 22. That is to say, the sharp corners associated with sheet metal ducts are eliminated with the present invention, thereby minimizing the opportunity for injury when handling the duct 14.

Others of the ductwork components 12 are described in greater detail below. As a general statement, each of these components 12 is preferably identical in construction to the duct 14 described above, though different in shape and size. More particularly, each of the ductwork components 12 described below are provided as integrally formed tubular bodies consisting of a rigid, interior foam layer and an outer non-metal, preferably plastic, layer. In this regard, each of the ductwork components 12 described below are preferably rotational molded parts, having a closed cell interior foam layer that defines an interior surface of the particular component.

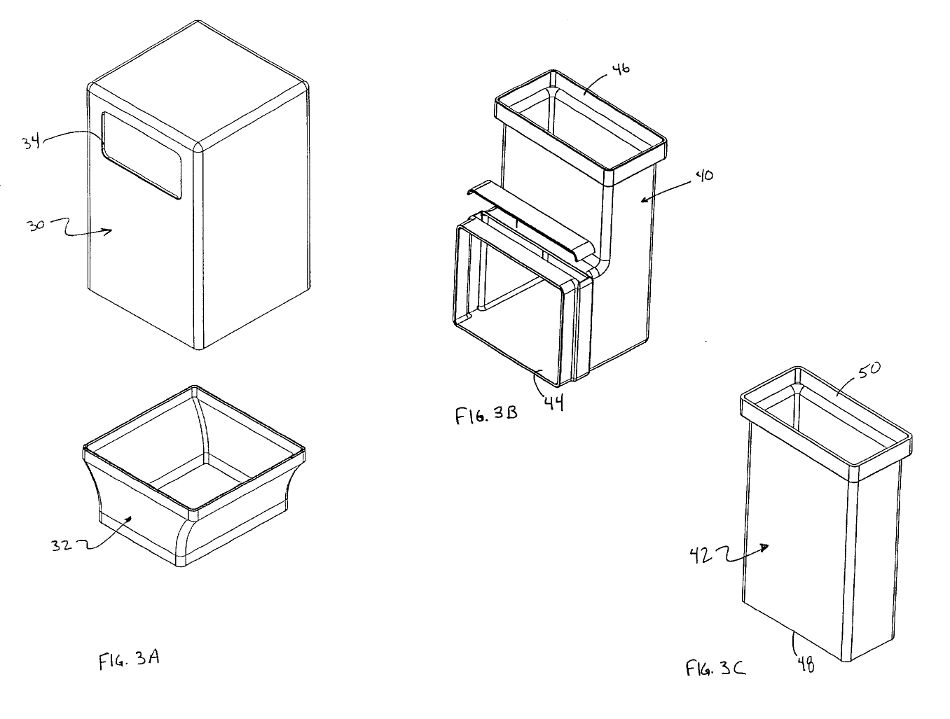

With additional reference to FIG. 3A, another of the ductwork components 12 of the present invention includes a hot air plenum 30. As is known in the art, the hot air plenum 30 is used to direct air from an air source 24 (shown in FIG. 1 as a heater or furnace) to other ductwork components. In this regard, the hot air plenum 30 is commonly used in combination with a hot air take-off component 32 that is also preferably provided in accordance with the present invention. Both the hot air plenum 30 and the hot air take-off 32 are preferably sized for assembly as shown in FIG. 1, with the hot air plenum 30 having a bottom opening (not shown) that is fluidly connected to the hot air takeoff 32. Further, the hot air plenum 30 defines one or more duct openings 34 (one of which is shown in FIGS. 1 and 3A) that are preferably cut into the hot air plenum 30 following the above described rotational molding process. Regardless, all exposed corners of the hot air plenum 30 and the hot air take-off 32 are rounded so to minimize the potential for handling injuries, as well as enhancing an aesthetic appearance of the components 30, 32.

In addition to the hot air plenum 30, the ductwork component 12 of the present invention can include a cold air plenum/take-off 40 or a cold air straight plenum 42 as shown in greater detail in FIGS. 3B and 3C, respectively. The cold air plenum/take-off 40 includes a first, male end 44 adapted for fluid connection to the air source 24 and a second, female end 46 adapted to receive a corresponding end of the cold air straight plenum 42 in an airtight relationship. Once again, the female end 46 is an integrally formed, outwardly extending flange with no sharp corners. The cold air straight plenum 42 similarly includes a male end 48 and a female end 50. The male end 48 is sized to be directly received within the female end 46 of the cold air plenum/take-off 40. Conversely, the female end 50 is adapted for direct coupling to other ductwork components, such as the duct 14a identified in FIG. 1.

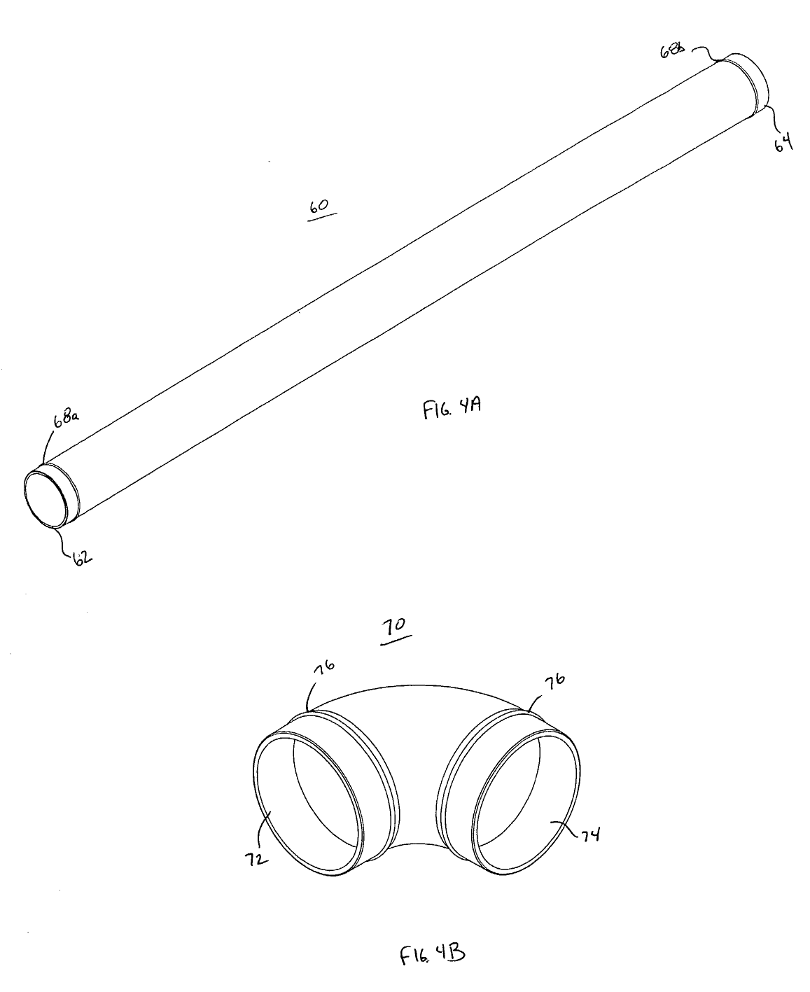

Additional ductwork components include straight pipes, an exemplary one of which is shown at 60 at FIG. 4A. Once again, the straight pipe 60 is an integrally formed, molded foam-based part defining opposing male ends 62, 64. Either of the male ends 62, 64 can be coupled to a corresponding female end of a separate ductwork component, or can be fluidly secured to a separate ductwork component via a ring clamp 66 (FIG. 1) that can be a known metal ring clamp commonly used in the HVAC industry. Alternatively, the pipe 60 can integrally form one of the ends 62, 64 as a female end (i.e., enlarged inner diameter) sized to receive the male end of a separate ductwork component. The straight pipe 60 can assume a wide variety of lengths. In a further preferred embodiment, the pipe 60 includes integrally formed, annular ribs 68a, 68b adjacent the ends, 62, 64, respectively. The annular ribs 68a, 68b provide a stop surface for mounting of the straight pipe 60 to a separate ductwork component. For example, as the male end 62 is inserted into a female end of the separate ductwork component, the annular rib 68a will contact the female end and prevent further insertion, thereby ensuring that a desired length of the pipe 60 is with the separate ductwork component. Similarly, where a ring clamp 66 is employed, the annular ribs 68a, 68b define a location point for the ring clamp 66 relative to the end 62, 64 being coupled.

Additionally, though not specifically shown in FIG. 1, the ductwork components 12 in accordance with the present invention can include a curved pipe 70 as shown in FIG. 4B. The curved pipe 70 is preferably molded to define opposing male ends 72, 74. Alternatively, one of the ends 72 or 74 can form a female end as previously described. In a further preferred embodiment, the molded, curved pipe 70 includes an integrally formed, annular rib 76 adjacent each of the ends 72, 74. Regardless, the curved pipe 70 can be formed to assume a wide variety of bend angles commonly utilized in the HVAC industry, for example, 22.5°, 45°, or 90°.

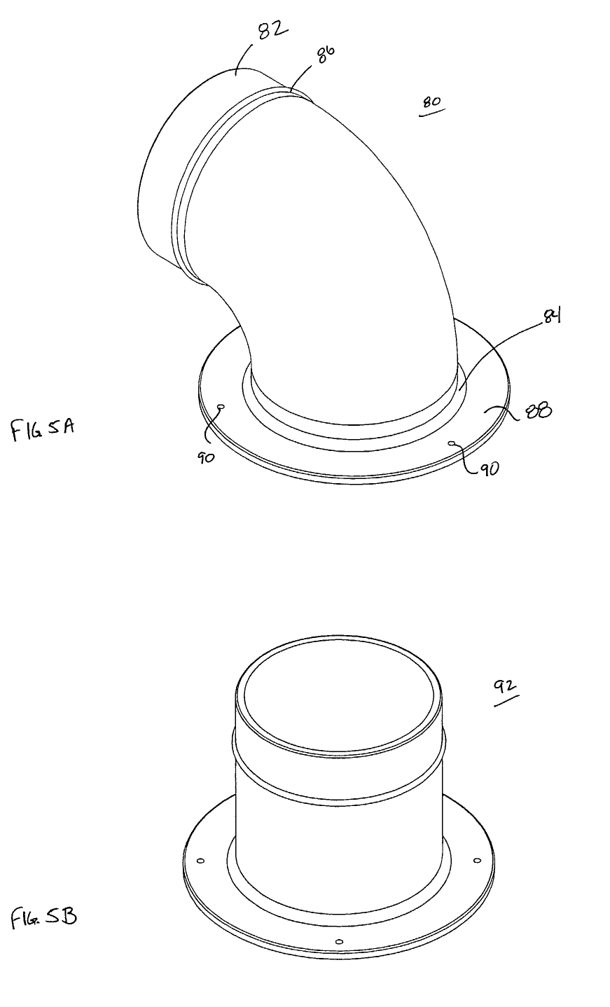

Yet another ductwork component 12 in accordance with the present invention is a curved duct take-off component 80 as shown in greater detail in FIG. 5A. The curved duct take-off 80 is employed to define an airflow branch off of a duct (such as the duct 14c in FIG. 1). With this in mind, the curved duct take-off 80 integrally defines a male end 82 and a female end 84. Further, an annular rib 86 is preferably integrally molded adjacent the male end 82. The female end 84 includes an enlarged, outwardly extending flange 88 into which several holes 90 are formed following the molding operation. Screws or other available fastening components project through the holes 90 to fasten the flange 88, and thus the take-off 80, to the duct 14c. The curved duct take-off 80 can be formed to assume a wide variety of bend angles, but is preferably a 90° bend. Alternatively, a straight duct take-off 92 can be provided as shown in FIG. 5B.

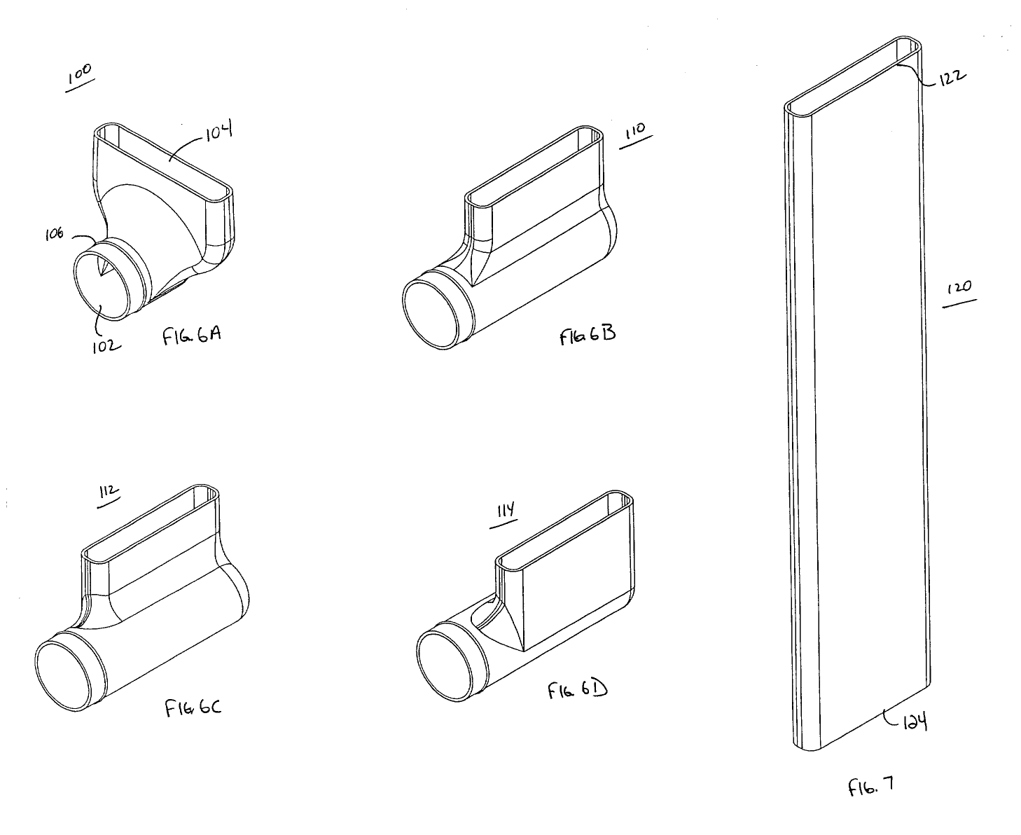

Yet another ductwork component 12 in accordance with the present invention is a boot, such as a 90° floor boot 100 shown in greater detail in FIG. 6A. The 90° floor boot 100 is similar to conventional HVAC floor boots in terms of size and shape, but is an integrally molded, foam-based component. In this regard, the 90° floor boot 100 integrally forms a pipe end 102 and a stack end 104, and preferably includes an annular rib 106 adjacent the pipe end 102. The stack end 104 is sized for coupling to a corresponding ductwork component (such as a wall stack or register as described below). Alternatively, the stack end 104 can define a female end sized to directly receive a male end of the corresponding ductwork component. Alternative boot constructions in accordance with the present invention include a straight floor boot 110 (FIG. 6B), a left hand floor boot 112 (FIG. 6C), and a right hand floor boot 114 (FIG. 6D).

Yet another ductwork component 12 in accordance with the present invention is a wall stack 120, shown in greater detail in FIG. 7. The wall stack 120 integrally forms opposing male ends 122, 124. The male ends 122, 124 are sized to be directly received, in an airtight relationship, within the female end of a corresponding boot where provided. Alternatively, a coupler device (not shown in FIG. 1) can be employed where the boot does not include a female stack end.

Returning to FIG. 1, other ductwork components 12 available with the present invention include a reducer 128, a wall register 130, a wall register coupler 132, a floor register coupler 134, and plenum duct couplers 136. Additionally, the ductwork components 12 can include components not specifically illustrated in FIG. 1 but commonly used as air handling system ductwork, such as tees, elbows, etc.

### EXAMPLES

Ductwork components in accordance with the present invention were produced. In particular, 8″×16″ five-foot ducts, 16″×14″ reducers, and 6″ 90° take-offs ductwork components were rotational molded at Custom Roto-Mold, Inc. of Benson, Minn., using a customized rotational molding machine manufactured by Ferry Industries, Inc., of Stow, Ohio. For each of the ductwork components, an appropriately sized and shaped mold was formed and mounted within the rotational molding machine. A LLDPE resin available under the trade designation “LL8460” from ExxonMobile of Toronto, Ontario, Canada, was loaded into the mold, and the rotational molding machine operated (e.g., heated and bi-axially rotated) for approximately 10 minutes, resulting in a thin layer of LLDPE being formed along the mold wall. Cycling of the rotational molding machine was then stopped, and a foaming agent, available under the trade name “Celogen” from UniRoyal Chemical Company, of Hartford, Conn., was dispensed into the mold. The ratio of foaming agent:LLDPE was 3:2. Operation of the rotational molding machine was then resumed for approximately 40 minutes, including a cooling cycle. The resulting ductwork component was removed from the mold.

Each of the ducts, reducers and 90° take-offs produced above included a rigid, closed cell foam interior layer. Each ductwork component was properly sized for use in an air handling system, and exhibited minimal heat transfer. All exterior surfaces were highly smoothed, and readily resisted scratching or other forms of deterioration.

As should be evident from the above, the present invention is in no way limited to circular pipes. Instead, virtually any ductwork component is available with the present invention. In a preferred embodiment, all major ductwork of a particular air handling system is comprised of components provided in accordance with the present invention. During assembly, the precisely defined male and female ends of the respective components are easily and directly joined to one another and produce an airtight fitting without the requirement of a separate sealing material. Of course, some installation layouts may require modification of one or more of the ductwork components 12, such as, for example, creating a hole through one of the ducts 14 to facilitate fluid coupling to another component, such as a take-off. Alternatively, however, one or more of the ductwork components can be of a conventional type (i.e., sheet metal), with the corresponding ductwork component in accordance with the present invention being easily joined thereto (e.g., a floor boot in accordance with the present invention being assembled to a metal straight pipe). Even further, ductwork components in accordance with the present invention can be used to retrofit an existing system. For example, an existing air handling system can include a number of different ductwork components, each formed of conventional sheet metal or galvanized steel. In the event that a particular ductwork component requires replacement (e.g., a floor boot has been damaged or otherwise deteriorated), the existing, metal boot is simply removed and replaced with the integrally molded, foam insulated boot in accordance with the present invention.

In light of the above, the present invention provides a marked improvement over previous designs. Ductwork components in accordance with the present invention represent a significant improvement over conventional, metal designs. There is no need for additional insulation to be applied during an installation procedure, as the foam interior layer is highly energy efficient. Further, the preferred rotational molding technique renders the resulting ductwork component smooth, with rounded corners. The ductwork components are non-toxic, non-allergenic, and water resistant. Further, the precise dimensional characteristic of each component are such that a sealed relationship is achieved upon joining two components, eliminating the need for duct tape or other sealant materials.

Although the present invention has been described with reference to preferred embodiments, workers skilled in the art will recognize that changes can be made in form and detail without departing from the spirit and scope of the present invention.

What is claimed is:

1. A ductwork component for a residential, commercial or industrial air handling system, the ductwork component comprising a tubular, rigid foam interior layer integrally formed with a thin, non-metal outer layer, the combination interior and outer layers characterized as providing requisite strength for use of the component within an air handling system without inclusion of a metal-based layer.

2. The ductwork component of claim 1, wherein the ductwork component is formed as a component body selected from the group consisting of a duct, pipe, elbow, boot, tee, reducer, coupling, register, wall stack, take-off and plenum.

3. The ductwork component of claim 2, wherein the ductwork component is an HVAC floor boot.

4. The ductwork component of claim 1, wherein the interior layer includes a closed cell foam.

5. The ductwork component of claim 4, wherein the closed cell foam is a molded polyethylene foam.

6. The ductwork component of claim 5, wherein the closed cell foam is a molded linear low-density polyethylene foam.

7. The ductwork component of claim 1, wherein the outer layer is plastic.

8. The ductwork component of claim 7, wherein the outer layer is linear low-density polyethylene.

9. The ductwork component of claim 1, wherein the outer layer has a thickness of not greater than 0.125 inch.

10. The ductwork component of claim 1, wherein the interior layer is adapted to have an R value of at least 18.

11. The ductwork component of claim 1, wherein the component defines a female end configured for air tight mating with an existing, metal-based air handling system ductwork component.

12. The ductwork component of claim 1, wherein the interior and outer layers are molded to one another.

13. The ductwork component of claim 12, wherein the interior and outer layers are rotational molded to one another.

14. The ductwork component of claim 12, wherein the interior and outer layers are injection molded to one another.

15. The ductwork component of claim 1, wherein the foam interior layer defines an innermost surface of the ductwork component.

16. The ductwork component of claim 1, further comprising a thin, nonmetallic inner layer integrally formed along an inner surface of the interior layer.

17. A method of manufacturing a ductwork component for a residential, commercial, or industrial air handling system, the method comprising:
providing a foam-related material;
providing a plastic material; and
molding the foam-related material and the plastic material to form the ductwork component comprising a tubular interior foam layer and a plastic outer layer;
wherein the step of molding results in the ductwork component being adapted for use in an air handling system and having a requisite strength without requiring an additional metal layer.

18. The method of claim 17, wherein the step of molding includes forming a component body replicating a shape of a ductwork device selected from the group consisting of a duct, pipe, elbow, boot, tee, reducer, coupling, register, wall stack, take-off, and plenum.

19. The method of claim 18, wherein the ductwork component is a plenum.

20. The method of claim 17, wherein the step of molding includes rotational molding the foam-related and plastic materials.

21. The method of claim 20, wherein the step of providing a foam-related material includes providing a foaming agent.

22. The method of claim 21, further comprising the step of combining the foaming agent and the plastic material as part of the step of rotational molding the materials.

23. The method of claim 22, wherein rotational molding the materials includes:
loading a rotational mold with the plastic material;
initiating a rotational molding operation by heating and rotating the mold; and
adding the foaming agent prior to completion of the rotational molding operation.

24. The method of claim 20, wherein the step of providing a plastic material includes providing a polyethylene resin.

25. The method of claim 24, wherein the polyethylene resin is a linear low-density polyethylene resin.

26. The method of claim 20, wherein the step of rotational molding includes formulating a molding composition consisting of approximately 60% of the foam-related material and approximately 40% of the plastic material.

27. The method of claim 17, wherein the step of molding includes:
forming the plastic material as an outer layer; and
injection molding the foam-related material to an interior of the outer layer.

28. The method of claim 17, wherein the outer layer has a thickness of not greater than 0.125 inch.

29. The method of claim 17, wherein the interior layer is a closed cell foam.

30. The method of claim 17, further comprising:
providing a mold shaped to replicate a shape of a known air handling system component; and
molding the ductwork component within the mold.

31. A method of replacing an existing metal ductwork component of an air handling system, the method comprising:
providing an integrally formed, foam-based ductwork component sized and shaped to replicate a size and shape of the existing component;
removing the existing metal ductwork component from the air handling system; and
mounting the foam-based ductwork component within the air handling system to replace the existing metal ductwork component.

32. The method of claim 31, wherein the metal ductwork component and the foam-based ductwork component are selected from the group consisting of a duct, pipe, elbow, boot, tee, reducer, coupling, register, wall stack, take-off, and plenum.

33. The method of claim 32, wherein the metal ductwork component and the foam-based ductwork component are a register.

34. An air handling system including an air source and ductwork comprising at least one duct, at least one boot, and at least one register, wherein at least one of the duct, boot and register are provided in accordance with claim 1.

35. The air handling system of claim 34, wherein each of the duct, boot and register are provided in accordance with claim 1.
